(19) United States
(12) Patent Application Publication
(10) Pub. No.: US 2008/0269357 A1
(43) Pub. Date: Oct. 30, 2008

(54) RHEOLOGY MODIFIERS FOR SLURRIES HANDLING AND STORAGE

(75) Inventor: Francisco SOTILLO, Mulberry, FL (US)

Correspondence Address: DENNIS G. LAPOINTE;LAPOINTE LAW GROUP, PL, PO BOX 1294, TARPON SPRINGS, FL, 34688-1294, US

(73) Assignee: ARR-MAZ CUSTOM CHEMICALS, INC., Mulberry, FL (US)

(21) Appl. No.: 11/741,786

(22) Filed: Apr. 30, 2007

(51) Int. Cl. B01F 3/12

(52) U.S. Cl. 516/33; 516/9

(57) ABSTRACT

An improvement, of the technology for the reduction of viscosity of mineral slurries of high solids content using rheology modifiers during the preparation of slurries to be handled and stored. The improvement includes first, the addition of a combination of organic polymers and/or surfactants (dispersants) for the reduction of the viscosity of mineral slurries, and second, the addition of a stabilizer or thickener (shear thinning type of polymers) of a predetermined type and amount of these rheology modifiers.

### FIELD OF THE INVENTION

The present invention is related to improving the rheological behavior of mineral slurries of high solids content during handling and storage of them by pumping processes; transportation of slurries in vessels, such as railroad cars, tankers, and trucks; storage in deposits, holding tanks, thickeners, vaults, and other containers.

### BACKGROUND OF THE INVENTION

The use of dispersants to reduce the viscosity of mineral slurries has been known and used since 1923 (U.S. Pat. No. 1,446,378, U.S. Pat. No. 1,448,515A, and U.S. Pat. No. 1,454,838A). For this purpose, different type of components was used. Recently, a US Patent Application Publication US2004/0112834 A1 and International Patent Application WO 02/083592A1 was filed for the reduction of viscosity through the addition of viscosity modifying treatment to the mineral ore slurry for unit operations involving transport, pumping and agitation.

Presently, the trend in the development of large and medium size mines in the world is to transport their ores or final concentrates from the mine (usually in isolated areas) to the nearest transfer or port facility, and to backfill pipe stoppers by pipelines. Lately, examples of these new mines and projects were published in the literature; such as Los Pelambres Mine (Chile), Alumbrera Mine (Argentina), Los Bronces Mine (Chile), Agua Rica Project (Argentina), Ramu Project (Papua New Guinea), Garpenberg Mine (Sweden), and Antamine Mine (Peru) (E&MJ, Vol. 207, Nos. 6, 9 and 10).

Some of this type of applications used viscosity modifier treatment to reduce viscosity. However, there is a great necessity for maintaining the sedimentation stability (use of a thickener or stabilizer) of mineral slurries of high solids content in the presence of aggregative stability reagents (dispersants or viscosity reducers).

The present invention makes it possible to overcome this apparent opposite rheological modifiers effects pointed out by Botsaris G. D. and Glazman Y. M., 1989, “Stability and Rheology of Coat Slurries,” in Interfacial Phenomena in Coal Technology, pp 199-277; Shaw D. J. in Introduction to Colloid and Surface Chemistry, 236 pp; and Kim Y. H. in Coagulation and Flocculation, Theory and Practice, 85 pp. In this literature, it is described the mechanism of dispersion by the modification of the Electrical Double Layer, the hydration or solvation, stearic interactions, and exclusive volume, which resulted in the decrease of the viscosity. In contrast, flocculation or aggregation mechanisms of thickeners or stabilizers considered to bring about agglomerate of particles due to Double Layer compression, polymer bridging, and enmeshment which increase viscosity. Klimpel R. R. in Introduction of Chemicals used in Particle Systems presented these apparent opposite functions of reagents as dispersants, and flocculants, stabilizers or thickeners.

The seemly incompatibility of the dual use of dispersants and stabilizers or thickeners has been overcome in this invention by the appropriate selection the dispersant and thickener, their corresponding amounts and sequencing that promote a synergistic benefit for the handling and storage of mineral slurries of high solids content. Under the conditions described in this invention, the viscosity of mineral slurries of high solids content is reduced using dispersants (polymers and/or surfactants blends) and this viscosity is kept reduced in the presence of the stabilizer or thickener polymers, as long as shearing is maintained. However, in non-shearing conditions, such as during storage, pump failure and/or energy disruptions; the system is stabilized avoiding the sedimentation of fine particles. As a consequence, handling of mineral slurries of high solids content will be done at lower viscosity than in the absence of rheological modifiers. Storage will be carried out without fine particles sedimentation and formation of hard sedimented cakes, and re-starting of slurries handling systems after periods of storage will be easy to achieve. These benefits will result in lower energy and/or water consumption.

Thus, using the present invention could produce the following: Increased solids content in mineral slurries, thus increased pumping capacity, increased pumpability of the mineral slurries; reduce viscosity; reduced handling and storage energy consumption; reduced water consumption; reduce capital and operating costs of a pipeline system and/or handling and storage systems; avoid plugging (choking) of pipelines in the event of power or pump disruption or failure; and allow to transfer and transport in vessels, such as railroad cars, tankers, and trucks, and to storage in deposits, holding tanks, thickeners, vaults, and other containers.

### SUMMARY OF THE INVENTION

The invention improves the current technology for reducing viscosity of mineral slurries of high solids content using rheology modifiers, allowing a more efficient handling and storage. For this purpose, a combination of dispersants and stabilizers or thickeners is used of a predetermined type, dosage, and sequence of addition. This results in a not expected synergetic benefit of reducing the viscosity of mineral slurries in the presence of shear stress, and maintaining sedimentation stability of the mineral slurry of high solids content in the absence of shear stress.

The invention comprises:
First, adding a dispersant or viscosity reducer, which is a combination of organic polymers, surfactants and blends of polymers and surfactants, as described in U.S. Pat. No. 6,805,242, which is incorporated herein by reference in its entirety. The dispersant described in U.S. Pat. No. 6,805,242 is known also under the trade name Polymer 1111™ manufactured by ARR-MAZ Custom Chemicals, Inc. of Mulberry, Fla., U.S.
Second, the addition of a sedimentation stabilizer or thickener, bio-natural or organic shear-thinning polymers. These polymers corresponded to carregeenan, a naturally-occurring family of carbohydrates extracted from red seaweed; microcrystalline cellulose (MCC), derived from naturally occurring cellulose found in fruits and vegetables; and combinations of these sedimentation stabilizers or thickeners. These polymers are also known under the trade name Polymer 2X™ manufactured by ARR-MAZ Custom Chemicals, Inc. of Mulberry, Fla., U.S.
A ratio between the dispersant and the stabilizer of about 20:1 to about 5:1, depending on the type and characteristics of the mineral slurries.

The use of this invention results in increase solids content in mineral slurries, thus an increase in pumping capacity; increase pumpability of the mineral slurries; reduced viscosity; reduced handling and storage energy consumption; reduced water consumption; reduced capital and operating costs of a pipeline system and/or handling and storage, systems; avoidance of plugging (choking) of pipelines in the event of power or pump disruption or failure; and allow to transfer and transport in vessels, such as railroad cars, tankers, and trucks, and to storage in deposits, holding tanks, thickeners, vaults, and other containers.

### DETAILED DESCRIPTION OF THE INVENTION

This invention refers to the technology for handling and storage of mineral slurries of high solids content developed based on both engineering conceptual design and rheological principles. When handling slurries of high solids content, several factors have to be taken into consideration, factors not being taken into consideration in the prior art. These factors include events, such as shutdown of a pumping system under partial or full load in the presence of rheology modifiers that decreased the viscosity (dispersants). This is caused by electrical, pump, and/or sudden pipeline or valve failures, and storage steps before, in between, or at the end of the handling and storage system for mineral slurries of high solids content.

Under these conditions, the eventual sedimentation of fines dispersed may result in a hard cake at the bottom of the pipe, channel, storage holding tank, container, vessel, vault, railroad car, truck, thickener, tanker, or deposit, plugging or choking the handling and storage system. Moreover, re-establishing the handling and storage steady state conditions would render high-intensity current consumption peaks and over-heating of electrical controls.

Consequently, the present invention refers to a technological sound system that improves the handling and storage of mineral slurries of high solids content. This novel technology includes an efficient rheology modifier that increases the aggregative stability (dispersant or viscosity reducer), such as Polymer 1111 made by ARR-MAZ Custom Chemicals, Inc. of Mulberry, Fla., U.S., and is further described in U.S. Pat. No. 6,805,242; and a rheology modifier that increases sedimentation stability (stabilizer or thickener), such as Polymer 2X also made by ARR-MAZ Custom Chemicals, Inc. The latter is a bio-natural polymer. This technology results in reducing viscosity, reducing the sedimentation of fine particles, and minimizing the gel strength of the slurry.

These results are unexpected synergetic effects of the dual use of apparently incompatible rheological modifiers, dispersants and stabilizers or thickeners. The technology assumes an appropriately ground material that produces the most desirable particle size distribution for the lowest viscosity of mineral slurries of high solids content in the absence of rheology modifiers. This invention includes:
First, the addition of a rheology modifier that increases the aggregative stability (dispersant), thus reducing the viscosity.
Second, the addition of a rheology modifier that increases sedimentation stability (stabilizer or thickener) without increasing the viscosity of the slurry in the presence of shear stress, and minimizing the gel strength at re-establishing shear stress conditions.
   Therefore, the stabilizer or thickener is designed to take over the control of the rheology of the handling and storage system in the absence of shear stress.

In the presence of dispersant and stabilizer or thickener, the handling and storage system is dominated by the dispersant in the presence of shear stress, which results in the reduction of viscosity of the mineral slurries at high solids content. In the absence of shear stress (sudden shutdown of the handling means or a storage step), the stabilizer or thickener dominates the system developing an inter-particle network that keeps fine particles in suspension and reduces the strength of the sedimented solids. Once shear stress is re-established, the dispersant dominates the system again. Since re-establishing the conditions in the handling requires energy consumption, the stabilizer or thickener should be strong enough to keep the particles in suspension for a period of time in the absence of shear stress, and weak enough to avoid an increase in energy required re-establishing the handling conditions. This requires the appropriate selection of the dispersant (such as Polymer 1111) and the stabilizer or thickener (such as Polymer 2X) to achieve this synergetic effect.

This disclosure describes three laboratory examples of the application of this novel technology on phosphate concentrate from Western U.S. phosphate ore and on a phosphate matrix from a Central Florida deposit. To evaluate the apparent viscosity of mineral slurries of high solids content; two types of viscosity measurements and three pieces of equipment were used, Brookfield Viscometer Model RVDV+Digital Viscometer with Spindle #3 without guard, Brookfield LVT Viscometer with spindle #1 without guard, and Zhan cup of 150 ml and 3.175 mm discharge orifice. The stability was determined by the “Penetration Test” used in the Coal Industry, which determine the percentage of volume occupied by solids after a given period. The smaller the percentage, the less sedimentation stability of the slurry is obtained. Gel strength was calculated using Brookfield conversion factor for Spindle #3 (Mitska P. M., “Simple. Conversion of Brookfield RVT Readings into Viscosity Functions.” Rheologica Acta, Vol. 21, 1982, pp. 207-209). The smaller the value of yield strength obtained in Pascal, the less energy required to re-establishing flow conditions and the less the hard-sediment cake form.

The selection and amount of dispersant and stabilizer or thickener added in the above described sequence could change from those used in this invention. Polymer 1111 and Polymer 2X (bio-natural polymer), to others of similar characteristics.

The effectiveness of this invention can be demonstrated in the following examples.

### EXAMPLE 1

The application of Polymer 1111 and Polymer 2X in the sequence described above were added to a phosphate concentrate slurry of high solids content and compared with those results obtained in the absence of rheology modifiers. The laboratory tests were conducted using U.S. Western Phosphate concentrate, and the data was reported in percentage of the Baseline sample in the absence of rheology modifiers.

TABLE I
For Different Solids Content

| | | P-1111 | P-2X | App. Visc. | | Gel Strength |
|---|---|---|---|---|---|---|
| Test | Solids % | Kg/ton | Kg/ton | Reduc. % | Penetration % | Reduc. % |
| Baseline | 62 | 0.000 | 0.000 | 0 | 71.82 | 0 |
| Rheo. Mod. | 62 | 0.011 | 0.002 | 17 | 81.25 | — |
| Baseline | 66 | 0.000 | 0.000 | 0 | 81.25 | 0 |
| Rheo. Mod. | 66 | 0.033 | 0.004 | 15–20 | 87.50 | 15 |
| Baseline | 70 | 0.000 | 0.000 | 0 | 89.50 | 0 |
| Rheo. Mod. | 70 | 0.038 | 0.007 | 21–25 | 90.00 | 10 |
| Baseline | 73 | 0.000 | 0.000 | 0 | >90.00 | 0 |
| Rheo. Mod. | 73 | 0.200 | 0.014 | 35 | >91.00 | — |

Clearly, the data showed that as the solids content increased, the beneficial effects of adding these rheology modifiers increased. First, the apparent viscosity of the slurry was reduced between 1.5% to 35% with respect to the corresponding solids content slurry in the absence of rheology modifiers, increasing as the solids content of the slurry increased. Second, the “Penetration Tests” showed that by using this invention the sedimentation stability of the system increased for all solids content of the slurries tested. At the lowest solids content (62%) the stability increased by about 10% with respect to that obtained in the absence of rheology modifiers, whereas at the highest solids content tested (73%) little difference was observed on the stability by this method of evaluation. Finally, the results showed that, the gel strength was reduced between 10%-15% using this invention for a given solids content with respect to that obtained in the absence of rheology modifiers.

These measurements demonstrate the unexpected synergetic effect of using a combinations of a dispersant (viscosity reducer) with a stabilizer or thickener (viscosity increaser), seemly incompatible, but that improved the handling and storage of mineral slurries of high solids content. Moreover, it demonstrates that the rheology modifier dosage and sequence are of utmost importance to obtain the unexpected-positive synergetic effect described in this disclosure.

### EXAMPLE 2

These tests were aimed at showing the effect of selecting the appropriate combination of dispersant and stabilizer or thickener to obtain a reduction of the apparent viscosity, an increase in the sedimentation stability, and the reduction of the gel strength. For this purpose, a Western U.S. Phosphate concentrate was used at 66% solids content slurry in which different rheology modifiers were used. The Standard tests corresponded to the addition of Polymer 1111 (0.033 Kg/ton) and Polymer 2X (0.004 Kg/ton) in the described sequence of this invention, whereas the use of a given thickener was specified in Table II.

TABLE II
Selection of Rheology Modifiers

| | Dosage | App. Visc. | Penetration | Gel Strength |
|---|---|---|---|---|
| Test | Kg/ton | Change. % | % | Change. % |
| No Rheo. Mod. | 0.000 | 0 | 81.25 | 0 |
| Standard | — | −15 to −20 | 87.50 | −15 |
| Xanthan Gum | 0.005 | −6 | 86.28 | 0 |
| Guar Gum | 0.006 | 0 | 86.54 | +10 |
| Minstar 2100 Starch | 0.005 | +5 | 88.46 | +15 |

The results clearly showed that the selection of the rheology modifiers strongly influenced the outcome of this invention, if another type of stabilizer or thickener is selected, the sedimentation stability may be slightly improved, but the apparent viscosity could go from almost no reductions of it (Xantham Gum and Guar Gum) to an increase (Minstar 2100 Starch). The gel strength increased for all the different stabilizers or thickeners tested, showing an increase in the energy demanded to re-establishing flow conditions.

### EXAMPLE 3

In this case, a sample of Central Florida Phosphate Matrix was used at 24% solids content slurry. This sample contained a significant amount of clays, which made the slurry significantly more viscous than a clay free mineral slurry of the same solids content. Table III summarized the results.

TABLE III
Effect on Dosages of Clayed Materials

| | | P1111 | P-2X | App. Visc. | | Gel Strength |
|---|---|---|---|---|---|---|
| Test | Solids % | Kg/ton | Kg/ton | Reduc. % | Penetration % | Reduc. % |
| No Rheo. Mod. | 24 | 0.000 | 0.000 | 0 | 68.50 | 0 |
| Rheo. Mod. | 24 | 0.630 | 0.030 | 65 | 77.00 | 23 |

Again, the results showed that at high dispersant and stabilizer or thickener addition the apparent viscosity was strongly reduced (65%), but still the sedimentation stability (as indicated by the Penetration Test) was increased (77%), and the gel strength, was reduced (23%). Consequently, the selection of the rheology modifiers, amounts used, and sequence of addition for a given mineral slurry of high solids content are of utmost importance for the successful application of this invention.

To summarize again, the invention is:

1. A novel and improved method for the handling and storage of mineral slurries of high solids content that reduces the viscosity, increases the sedimentation stability, but reduces the gel strength, using a sequence of addition in which a dispersant (viscosity reducer) is first added following by the addition of a stabilizer or thickener of the desired predetermined type of stabilizer or thickener and amount.

2. A novel and improved method for the handling and storage of mineral slurries of high solids content that reduces the viscosity, increases the sedimentation stability, but reduces the gel strength in the sequence described in 1. above, in which the dispersant is a polymer or surfactant, polymers or surfactants blends, and polymers and surfactant blends.

3. A novel and improved method for the handling and storage of mineral slurries of high solids content that reduces the viscosity, increases the sedimentation stability, but reduces the gel strength in the sequence, described in 1. above, in which the stabilizer or thickener is a shear-thinning type of bio-natural organic polymers, natural organic polymers, synthetic organic polymers or combinations thereof.

4. A novel and improved method for the handling and storage of mineral slurries of high solids content that reduces the viscosity, increases the sedimentation stability, but reduces the gel strength in the sequence described in 2. above, in which the stabilizer or thickener is a shear-thinning type of bio-natural organic polymers, natural organic polymers or synthetic organic polymers.

5. A novel and improved method for the handling and storage of mineral slurries of high solids content that reduces the viscosity, increases the sedimentation stability, but reduces the gel strength in the sequence described in 1. above, in which the ratio of dispersant to stabilizer or thickener is between about 20:1 to about 5:1, depending on the type and characteristics of the mineral slurry.

6. A novel and improved method for the handling and storage of mineral slurries of high solids content that reduces the viscosity, increases the sedimentation stability, but reduces the gel strength in the sequence, described in 1. above, where the dispersant is Polymer 1111 and the stabilizer or thickener is Polymer 2X.

7. A novel and improved method for the handling and storage of mineral slurries of high solids content that reduces the viscosity, increases the sedimentation stability, but reduces the gel strength in the sequence described in 5. above, where Polymer 1111 is used as high as about 0.700 Kg/ton and as low as about 0.043 Kg/ton.

8. A novel and improved method for the handling and storage of mineral slurries of high solids content that reduces the viscosity, increases the sedimentation stability, but reduces the gel strength in the sequence described in 5. above, where Polymer 2X is used as high as about 0.035 Kg/ton and as low as about 0.002 Kg/ton.

9. A novel and improved method for the handling and storage of mineral slurries of high solids content that reduces the viscosity, increases the sedimentation stability, but reduces the gel strength in the sequence described in 1 above, wherein method is used to increase solids content in a mineral slurry, thus increasing pumping capacity.

10. A novel and improved method for the handling and storage of mineral slurries of high solids content that reduces the viscosity, increases the sedimentation stability, but reduces the gel strength in the sequence described in 1. above, wherein the method is used to increase pumpability of mineral slurries, thus reducing viscosity.

11. A novel and improved method for the handling and storage of mineral slurries of high solids content that reduces the viscosity, increases the sedimentation stability, but reduces the gel strength in the sequence described in 1. above, wherein the method is used to reduce handling and storage energy consumption.

12. A novel and improved method for the handling and storage of mineral slurries of high solids content that reduces the viscosity, increases the sedimentation stability, but reduces the gel strength in the sequence described in 1. above, wherein the method is used to reduce water consumption in handling and storage systems.

13. A novel and improved method for the handling and storage of mineral slurries of high solids content that reduces the viscosity, increases the sedimentation stability, but reduces the gel strength in the sequence described in 1. above, wherein the method is used to reduce capital and operating costs of a pipeline system, and/or handling and storage systems.

14. A novel and improved method for the handling and storage of mineral slurries of high solids content that reduces the viscosity, increases the sedimentation stability, but reduces the gel strength in the sequence described in 1. above, wherein the method is used to avoid plugging or choking of pipelines in the event of power or pumping disruption or failure.

15. A novel and improved method for the handling and storage of mineral slurries of high solids content that reduces the viscosity, increases the sedimentation stability, but reduces the gel strength in the sequence described in 1. above, wherein the method is used to allow the storage, and transfer, in holding tanks, deposits, vaults, thickeners, other containers, and transport in trucks, railroad cars, and tankers.

It should be understood that the preceding is merely a detailed description of one or more embodiments of this invention and that numerous changes to the disclosed embodiments can be made in accordance with the disclosure herein without departing from the spirit and scope of the invention. The preceding description, therefore, is not meant to limit the scope of the invention. Rather, the scope of the invention is to be determined only by the appended claims and their equivalents.

What is claimed is:

1. A method for the handling and storage of mineral slurries of high solids content that reduces the viscosity, increases the sedimentation stability, but reduces the gel strength, comprising:
using a sequence of addition in which a viscosity reducer dispersant is first added following by an addition of a sufficient amount of a predetermined stabilizer or thickener serving as a rheology modifier.

2. The method according to claim 1, wherein said dispersant is a polymer or surfactant, polymers or surfactants blends, and polymers and surfactant blends.

3. The method according to claim 1, wherein said stabilizer or thickener has a shear-thinning characteristic and is made from bio-natural organic polymers, natural organic polymers, synthetic organic polymers or combinations thereof.

4. The method according to claim 2, wherein said stabilizer or thickener has a shear-thinning characteristic and is made from bio-natural organic polymers, natural organic polymers, synthetic organic polymers or combinations thereof.

5. The method according to claim 1 above, wherein a ratio of dispersant to stabilizer or thickener is between about 20:1 to about 5:1.

6. The method according to claim 1, wherein said the dispersant is a Polymer 1111™ polymer and said stabilizer or thickener is a Polymer 2X™ polymer.

7. The method according to claim 5, wherein said Polymer 1111™ polymer is selectively used in a concentration of about 0.700 Kg/ton to about 0.043 Kg/ton.

8. The method according to claim 5, wherein said Polymer 2X™ polymer is selectively in a concentration of about 0.035 Kg/ton to about 0.002 Kg/ton.

9. The method according to claim 1, wherein method is used to increase solids content in a mineral slurry, thus increasing pumping capacity.

10. The method according to claim 1, wherein the method is used to increase pumpability of mineral slurries, thus reducing viscosity.

11. The method according to claim 1, wherein the method is used to reduce handling and storage energy consumption.

12. The method according to claim 1, wherein the method is used to reduce water consumption in handling and storage systems.
